(19) United States
(12) Patent Application Publication
(10) Pub. No.: US 2009/0049505 A1
(43) Pub. Date: Feb. 19, 2009

(54) MULTI-PURPOSE PORTABLE ELECTRONIC DEVICE

(75) Inventor: RAY L. LU, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: EGALAX_EMPIA TECHNOLOGY INC., TAIPEI CITY (TW)

(21) Appl. No.: 11/839,896

(22) Filed: Aug. 16, 2007

(51) Int. Cl. H04N 7/16

(52) U.S. Cl. 725/141

(57) ABSTRACT

Described is a multi-purpose portable electronic device which is capable of providing both TV and storage functions. By using the portable electronic device, a user can watch a TV program received externally, store the TV program in a single portable electronic device and watch the stored TV program on different computers at different locations. In addition, an application software necessary for operating the portable electronic device on the computer may be directly stored in the portable electronic device itself. As such, a promoted convenience and lower cost are achieved by the multi-purpose portable electronic device.

### BACKGROUND OF THE INVENTION

1. Field of the Invention

The present invention relates to a portable electronic device and, more particularly, to a multi-purpose portable electronic device.

2. Description of the Related Art

As the electronic technology greatly proceeds, universal serial bus (USB) interface has been developed for computer, which is an interface for the computer to have a peripheral electronic device or peripheral electronic devices connect thereto and work therewith, so that a specific function or functions can be achieved thereon. The electronic device(s) connecting to the computer is/are equipped with the so-called plug-and-play function and the electronic devices are connected in series in this configuration.

Portable electronic device is one form of the electronic devices and may be connected to the computer for a specific purpose via one of various kinds of interfaces, particularly the USB interface. The portable electronic device includes, but is not limited to, digital camera, MP3 player, personal digital assistant (PDA), cellular phone, portable digital TV card, one inch minihard drive, EZ-drive, etc. The content associated with the portable electronic device can be written from or uploaded to the computer connected therewith via the interface therebetween, thereby achieving the specific purpose.

Since the computer is capable of mass storage and strong data processing, the portable electronic device connected thereto can be benefited with control from the computer when working together therewith. Further, since the portable electronic device can be carried in hand, it has enjoyed a popularity in market. However, there are many kinds of function-specific portable electronic devices. At this time, a user has to pay a high cost and inconvenience if he/she desires to have several kinds of the portable electronic devices.

The followings will be dedicated to introduction of some such portable electronic devices, with reference to FIG. 1 and FIG. 2.

The portable TV card is a device through which the user can watch a TV program on a computer when the portable TV card is connected to the computer. FIG. 1 is a schematic diagram illustrating how the portable TV card works with the computer. As shown, the portable TV card 10 is connected to an external computer 15 and comprises a hybrid TV tuner module 11, a digital demodulation module 12, an analog decoding module 13 and a hybrid TV processing module 14. The hybrid TV processing module 14 comprises a digital processing interface 141, an analog processing interface 142 and a USB interface 143. The computer 15 comprises an application software (not shown) for accessing the portable TV card 10 at least including beginning or stopping a TV program.

When a user plays a TV program on the computer 15 by executing the application software thereon, the hybrid TV tuner module 11 receives a digital TV signal input TV_digital or an analog TV signal input TV_analog. Then, the hybrid TV tuner module 11 outputs a digital video/audio signal IF1 or an analog video signal input IF2 and an analog audio signal SIF. The digital TV signal input TV_digital and the analog TV signal input TV_analog may be a wireless TV signal or a cabled TV signal and comprises a video signal and an audio signal.

Next, the digital demodulation module 12 and analog decoding module 13 receive the digital video/audio signal IF1 or the analog video signal IF2 and the analog audio signal SIF, and demodulates the digital video/audio signal IF1 and decodes the analog video signal IF2 and analog audio signal SIF, respectively. Then, the digital demodulation module 12 and analog decoding module 13 output a demodulated digital video/audio signal TS, and a decoded digital video signal YUV and a decoded digital audio signal I²S/AC-Link, respectively. The decoded digital audio signals I²S and AC-Link are taken from two different digital audio signal systems, respectively, and one of which is employed. Thereafter, the digital processing interface 141 and analog processing interface 142 receive the demodulated digital video/audio signal TS, and the decoded digital video signal YUV and decoded digital audio signal I²S/AC-Link, respectively. Then, a computer interface signal CUSB is outputted from the hybrid TV processing module 14 to the computer 15 connected with the portable TV card 10 through the USB interface 143, in response to the received demodulated digital video/audio signal TS and decoded digital video signal YUV and the decoded digital audio signal I²S/AC-Link.

Other portable storage devices such as flash memory, card reader and one inch minihard drive devices are also allowed to be connected to a computer and work with each other. FIG. 2 shows an illustration where such portable storage device is connected to a computer and work therewith. As shown, the portable storage device 20 is connected to an external computer 23 and comprises a storage control module 21 and a storage module 22. The storage control module 21 comprises a storage interface 211 and a USB interface 212. The storage module 22 has data stored therein. The storage control module 21 reads data stored in the storage module 22 to the computer 23 or writes data to the storage module 22 from the computer 23 via the storage interface 211, a read/write bus Data/Address and the USB interface 212. As such, the data stored in the storage module 22 is uploaded to the computer 23 or the computer 23 transmits data to the portable storage device 20 at the storage module 22 through the storage control module 21.

Like other portable electronic devices, the above described portable TV card and portable storage device each have its own purpose. However, although the portable TV card is related to video and audio content, and the video and audio content is related a storage space. Or these portable devices may seek a wider range of functions. Therefore, there is a need to provide a portable TV card which can be enhanced in performance by considering the portable storage device in cooperation therewith.

### SUMMARY OF THE INVENTION

It is, therefore, an object of the present invention to provide a multi-purpose portable electronic device, a user stores receiving TV program through the multi-purpose portable electronic device and access TV program to play stored therein, so that cost thereof can be lowered and user convenience thereof can be enhanced.

In accordance with the present invention, the multi-purpose portable electronic device comprises a TV module having a hybrid TV tuner unit, a digital demodulation unit and an analog decoding unit, a storage module storing a data content, and a hybrid processing module having a digital processing interface, an analog processing interface, a storage interface and a universal serial bus (USB) interface. In the TV module, the hybrid TV tuner unit receives one of an external digital TV signal or an external analog TV signal each comprising a video signal and an audio signal, and outputting one of a digital video/audio signal, or an analog video signal and an analog audio signal in response thereto. The digital demodulation unit receiving the digital video/audio signal and outputting a demodulated digital video/audio signal in response thereto. The analog decoding unit receiving the analog video and audio signals and outputting a decoded digital video signal and a decoded digital audio signal in response thereto. The digital processing interface receives the demodulated digital video/audio signal. The analog processing interface receives the decoded digital video and audio signals, and the storage interface connected to the storage module through a data/address bus on which a data/address signal associated with the video and audio content is transmitted.

In operation, the hybrid processing module executes one of the following functions: playing a first content on the external computer corresponding to a first computer interface signal on the USB interface by receiving the first computer interface signal from the external computer through the USB interface in response to the received demodulated video/audio signal, the decoded digital video and audio signals and the data/address signal, storing the first content corresponding to a second computer interface signal on the USB interface to the storage module through the storage interface by receiving the second computer interface signal from the external computer through the USB interface, acquiring a second content corresponding to a third computer interface signal on the USB interface from the external computer from the storage module through the storage interface onto the external computer, and playing the stored second content corresponding to a fourth computer interface signal on the USB interface on the external computer.

In an embodiment, the storage module is selected from the group consisting of a one inch mini hard drive, a flash memory, and a card reader and a card readable by the card reader.

In an embodiment, the flash memory is integrally formed with the portable electronic device, and the small sized portable hard disk drive and card reader are integrally formed with or detachable from the portable electronic device.

By means of the portable electronic device, a user can watch a TV program received externally, store the TV program in a single portable electronic device and watch the stored TV program at different locations. In addition, an application software necessary for operating the portable electronic device on the computer may be directly stored in the portable electronic device itself. As such, a promoted convenience and lower cost are achieved by the multi-purpose portable electronic device.

### BRIEF DESCRIPTION OF THE DRAWINGS

The above and other objects of the present invention will become readily apparent by reference to the following detailed description when considered in conjunction with the accompanying drawings wherein:

FIG. 1 is a block diagram illustrating how a conventional portable TV card works with a computer in accordance with the prior art;

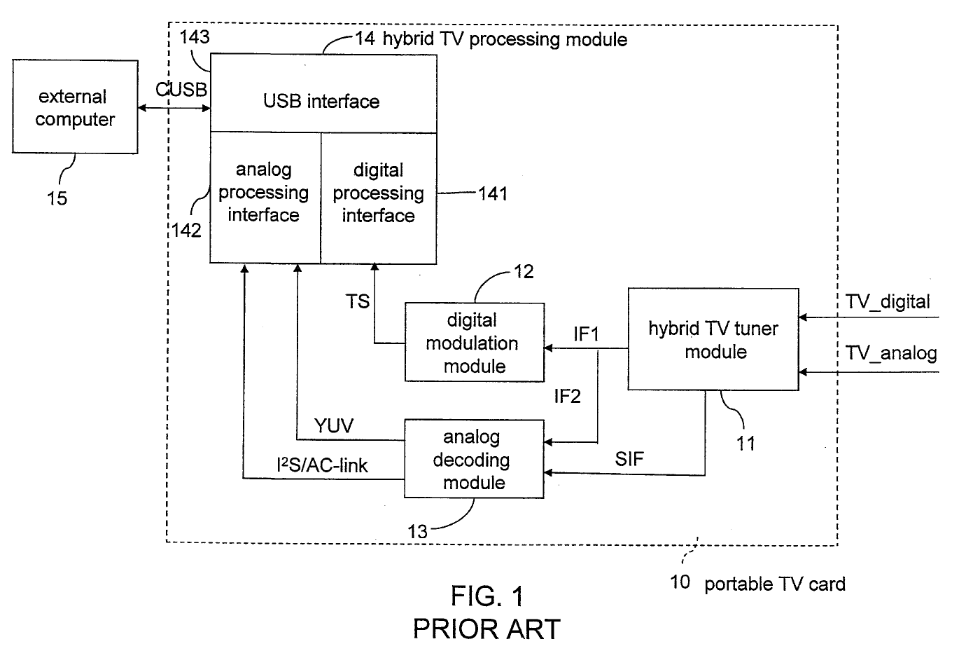

FIG. 2 is a block diagram illustrating how a conventional portable storage device works with a computer in accordance with the prior art; and

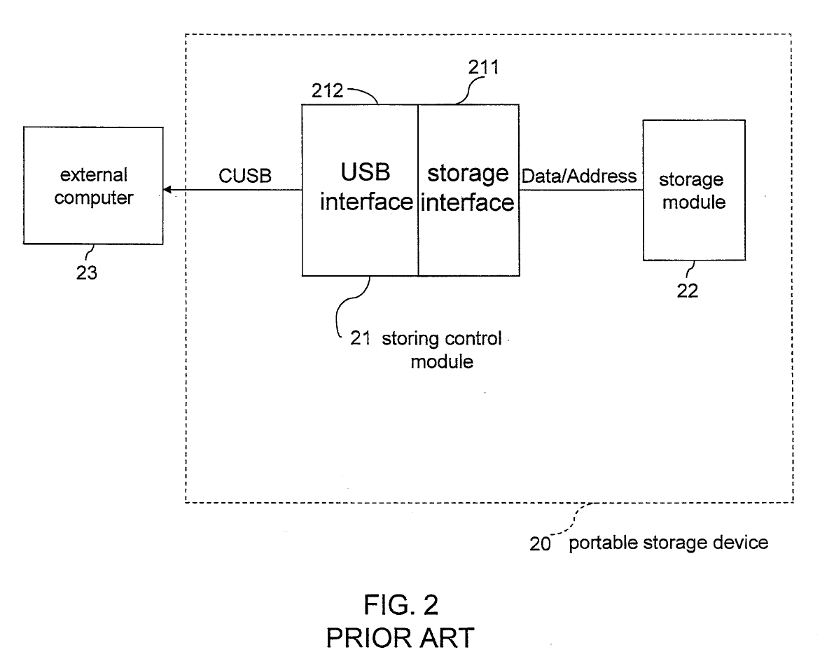

FIG. 3 is a block diagram illustrating how a multi-purpose portable storage device works with a computer in accordance with the present invention.

### DETAILED DESCRIPTION OF THE INVENTION

The present invention is a multi-purpose portable electronic device, which will be described taken in the preferred embodiments with reference to the accompanying drawings.

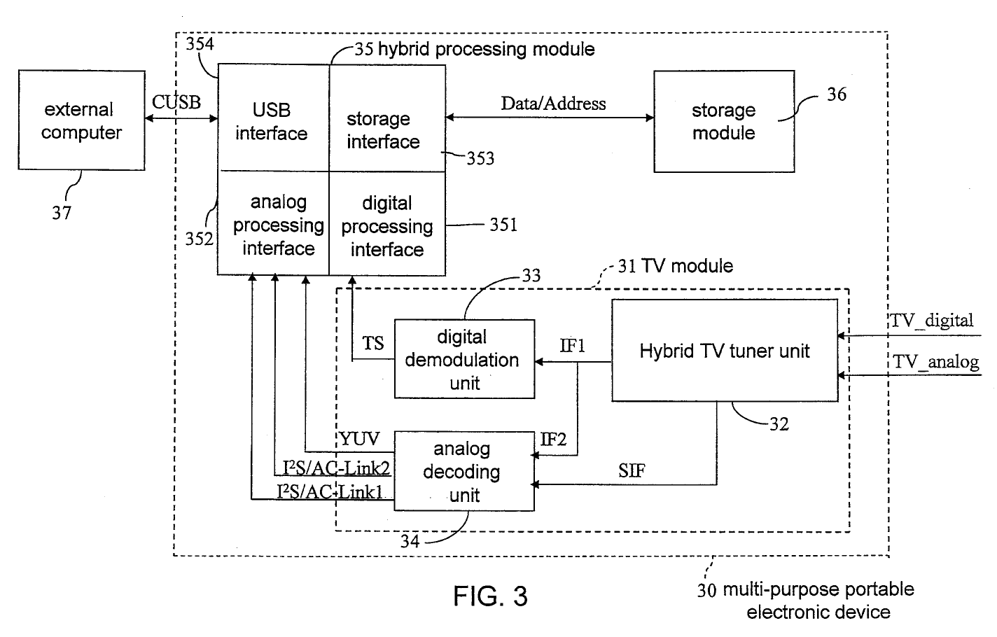

Referring to FIG. 3, the multi-purpose portable electronic device 30 is connected to an external computer 37 and comprises a TV module 31, a hybrid processing module 35 and a storage module 36. The TV module 31 comprises a hybrid TV tuner unit 32, a digital demodulation unit 33 and an analog decoding unit 34. The computer 37 comprises an application software (not shown), on which a user may execute specific actions for accessing the multi-purpose portable electronic device 30.

When a user executes a command “play” on the application software on the computer 36, the hybrid TV tuner unit 32 receives an external digital TV signal TV-digital or an external analog TV signal TV_analog. Each of the external digital and analog TV signals TV-digital and TV_analog may be a wireless TV signal or a cabled TV signal and comprises a video signal and an audio signal. The TV module 31 further comprises an antenna for receiving the wireless TV signal or a cable interface (not shown) for receiving the cabled TV signal through an external cable connecting thereto. In response to the external digital or analog TV signals TV-digital and TV_analog, the hybrid TV tuner unit 32 outputs a digital video/audio signal IF1, or an analog video signal IF2 and an analog audio signal SIF.

The digital demodulation unit 33 is used to receive the digital video/audio signal IF1 and output a demodulated digital video/audio signal TS in response to the received digital video/audio signal IF1.

The analog decoding unit 34 is used to receive the analog video signal IF2 and the analog audio signal SIF, and outputs a decoded digital video signal YUV and a decoded digital audio signal I²S/AC-Link in response to the received analog video signal IF2 and the analog audio signal SIF. The decoded digital audio signals I²S and AC-Link are taken from two different digital audio signal systems, respectively. Although only one of the decoded digital audio signals I²S and AC-Link is outputted in the present invention, they may both have its associated circuit disposed in the analog decoding module 34.

The hybrid processing module 35 has a digital processing interface 351, an analog processing interface 352, a storage interface 353 and a USB interface 354. The digital processing unit 351 is used to receive the demodulated digital video/audio signal TS. The analog processing unit 352 is configured to receive the decoded digital video and audio signals YUV and I²S/AC-Link. The storage interface 353 is connected to the storage module 36 via a data/address bus Data/Address, on which a data/address signal associated with the video and audio content is transmitted.

The storage module 36 may be a one inch mini hard drive or a flash memory. The flash memory is integrally formed with the portable electronic device 30 and the one inch mini hard drive is integrally formed with or detachable from the portable electronic device 30. The storage module 36 may further be a card reader and a card which can be read by the card reader. The card reader is integrally formed with or detachable from the portable electronic device 30, and the card is operable inserted into the portable electronic device 30. The one inch mini hard drive is described as “detachable” simply because it has a standard connector and the multi-purpose portable electronic device 30 also comprises a standard connector complemented thereto, which the standard connector of the one inch mini hard drive 38 may be connected to or detached from.

When the multi-purpose portable electronic device 30 receives a digital TV signal TV_digital or an analog TV signal from the external, the hybrid processing module 35 outputs a computer interface signal CUSB to the computer 37, enabling the computer 37 to play a content corresponding to the computer interface signal CUSB thereon. When the user sends a command “store” on the application software on the computer 37 for storing a TV program received externally, the hybrid processing module 35 stores a content corresponding to the computer interface signal CUSB to the storage module 36. When the user sends a command “acquire and play” on the application software on the computer 37, the hybrid processing module 35 acquires the stored content corresponding to the computer interface signal CUSB and then enables the computer 37 to play the content corresponding to the computer interface signal CUSB.

In addition, the application software is conventionally contained in an optical disk, so that the user may install the application software into the computer 37 by accessing the optical disk. However, the application software may be stored directly in the storage module 36 of the portable electronic device 30 in the present invention and thus do without the existence of the optical disk. At this time, if the user desires to re-install the application into the computer 37, he/she may finish the job with the aid of the storage module 36 and does not take any risk of loss of the optical disk, need to locate where the optical disk has been put, or need to worry about if the optical disk is hard to re-acquired. Accordingly, the use of the multi-purpose portable electronic device 30 is provided a good convenience.

Therefore, the user may watch a TV program received externally, store the TV program in a single portable electronic device and watch the stored TV program on any computer which the multi-purpose portable electronic device of the present invention is connected to. In addition, an application software necessary for operating the multi-purpose portable electronic device on the computer may be directly stored in the multi-purpose portable electronic device itself.

The above mentioned signals TV_signal, TV_analog, IF1, IF2, TS, YUV, I²S/AC-Link, Data/Address and CUSB are apparent to those skilled in the art and will be omitted herein for clarity.

By performing the present invention, the user may execute several functions by connecting a single portable electronic device to a computer, effectively enhancing the user convenience in terms of the desirable functions. In addition, the USB interfaces for the conventional portable TV card and the portable storage device are implemented as a single USB interface (i.e. the above described USB interface 354) when the conventional portable TV card and the portable storage device are incorporated into the multi-purpose portable electronic device of the present invention. As a consequence, the multi-purpose portable electronic device has a relatively reduced cost as compared to that of the conventional portable TV card and the portable storage device before being merged together. Of course, respective housings necessary for the conventional portable TV card and the portable storage device are relatively reduced as they are merged into the multi-purpose portable electronic device of the present invention.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What is claimed is:

1. A multi-purpose portable electronic device, comprising:
a TV module, comprising:
a hybrid TV tuner unit receiving one of an external digital TV signal and an external analog TV signal each comprising a video signal and an audio signal, and outputting one of a digital video/audio signal, and an analog video signal and an analog audio signal in response thereto;
a digital demodulation unit receiving the digital video/audio signal and outputting a demodulated digital video/audio signal in response thereto; and
an analog decoding unit receiving the analog video and audio signals and outputting a decoded digital video signal and a decoded digital audio signal in response thereto;
a storage module storing a data content; and
a hybrid processing module, comprising:
a digital processing interface receiving the demodulated digital video/audio signal;
an analog processing interface receiving the decoded digital video and audio signals;
a storage interface connected to the storage module through a data/address bus on which a data/address signal is transmitted; and
a universal serial bus (USB) interface connected to an external computer,
wherein a user sends a command from the external computer to the hybrid processing module through the USB interface to enable the multi-video/audio purpose portable electronic device to execute one of the following functions: playing on the external computer a first content corresponding to a first computer interface signal on the USB interface by receiving the first computer interface signal from the external computer through the USB interface in response to the received demodulated video/audio signal, the decoded digital video and audio signals and the data/address signal, storing the first content corresponding to a second computer interface signal on the USB interface to the storage module through the storage interface by receiving the second computer interface signal from the external computer through the USB interface, acquiring a second content corresponding to a third computer interface signal on the USB interface from the external computer from the storage module through the storage interface onto the external computer, and playing the stored second content corresponding to a fourth computer interface signal on the USB interface on the external computer.

2. The multi-purpose portable electronic device as claimed in claim 1, wherein the external computer includes an application software and the application software is executed by a user to play the first and second content on the external computer, respectively.

3. The multi-purpose portable electronic device as claimed in claim 2, wherein the application software is stored in the storage module before being installed into the external computer.

4. The multi-purpose portable electronic device as claimed in claim 1, wherein the storage module is a one inch mini hard drive or a flash memory.

5. The multi-purpose portable electronic device as claimed in claim 4, wherein the flash memory is integrally formed with the portable electronic device and the small sized portable hard disk drive is integrally formed with or detachable from the portable electronic device.

6. The multi-purpose portable electronic device as claimed in claim 4, wherein the storage module further comprises a card reader and a card readable by the card reader.

7. The multi-purpose portable electronic device as claimed in claim 6, wherein the card reader is integrally formed with or detachable from the multi-video/audio portable electronic device.

8. The multi-purpose portable electronic device as claimed in claim 7, wherein each of the external digital and analog TV signals is one of a wireless TV signal and a cabled TV signal.

9. The multi-purpose portable electronic device as claimed in claim 8, wherein the TV module further comprises an antenna receiving the wireless TV signal and a cable interface receiving the cable TV signal through an external cable connected thereto, respectively.
